(19) United States
(12) Patent Application Publication
(10) Pub. No.: US 2026/0120336 A1
(43) Pub. Date: Apr. 30, 2026

(54) GENERATION OF SYNTHESIZED IMAGES BASED ON IDENTIFICATION IMAGES

(71) Applicant: Lemon Inc., Grand Cayman (KY)

(72) Inventors: Tiancheng Zhi, Los Angeles, CA (US); Yimeng Zhang, Los Angeles, CA (US); Shen Sang, Los Angeles, CA (US); Jing Liu, Los Angeles, CA (US); Qing Yan, Los Angeles, CA (US); Liming Jiang, Los Angeles, CA (US); Linjie Luo, Los Angeles, CA (US)

(21) Appl. No.: 18/930,660

(22) Filed: Oct. 29, 2024

(51) Int. Cl. G06T 11/00; G06F 40/284; G06V 10/82; G06V 40/16

(52) U.S. Cl. CPC G06T 11/00; G06F 40/284; G06V 10/82; G06V 40/16; G06T 2200/24

(57) ABSTRACT

A computing system receives an input prompt and input images, generates identification images based on the input images, and generates identification patches based on the identification images, respectively. The system further generates a pose-patch image based on the identification patches and a pose image, and generates word tokens based on the identification images, respectively. Token embeddings are generated based on the input prompt, and the word tokens and the token embeddings are concatenated to generate concatenated token embeddings. The system inputs the pose-patch image and the concatenated token embeddings into a control network to generate features. Then the features, latent noise, and the concatenated token embeddings are inputted into a diffusion model to generate the synthesized image, and an output is generated based on the synthesized image.

### BACKGROUND

In the field of personalized image generation, creating visually coherent images that naturally integrate multiple concepts remains a challenging problem. One application involves generating images containing multiple distinct individuals interacting with each other in a realistic manner, each individual represented by a plurality of detected visual features of each individual derived from a reference photo.

Current approaches primarily rely on attention-based mechanisms, where generation of visual depictions of distinct individuals are controlled through masking of the attention maps at various stages of the generative process. While these techniques are able to ensure that different individuals are rendered in the same image with some accuracy, they are hindered by inherent limitations. Notably, these mask-based methods are prone to the issue of visual feature leakage through convolutional layers, especially when two people in the synthesized image are in close proximity or physically interacting. When this occurs, a visual feature associated with a first person who is in close proximity to a second person in an image might be identified and retained through the convolutional layers as being associated with both the first and second person. During generation, this visual feature of the first person could be mistakenly rendered in a mask region for the second person, resulting in leakage of the visual feature of the first person to the generated image of the second person. As a concrete example, this could result in the hairstyle of a first person being rendered incorrectly as the hairstyle of a second person. This inadvertent blending of person-specific visual features may result in visual output where distinct visual appearances are not well preserved, and the interactions of the individuals portrayed in the image appear unrealistic.

### SUMMARY

In view of the above issues, a computing system is provided for generating a synthesized image. The computing system includes a processing circuitry and memory storing instructions that, when executed, cause the processing circuitry to receive an input prompt and one or more input images, generate one or more identification images based on the one or more input images, and generate one or more identification patches based on the one or more identification images, respectively. The system further generates a pose-patch image based on the one or more identification patches and a pose image, and generates one or more word tokens based on the one or more identification images, respectively. Token embeddings are generated based on the input prompt. The one or more word tokens and the token embeddings are concatenated to generate concatenated token embeddings. The system inputs the pose-patch image and the concatenated token embeddings into a control network to generate features. Then the features, latent noise, and the concatenated token embeddings are inputted into a diffusion model to generate the synthesized image, and an output is generated based on the synthesized image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic view of a first computing system according to an example of the present disclosure.

FIG. 2 illustrates a schematic view of the operations of the trained machine learning diffusion model of the computing system of FIG. 1.

FIG. 3 illustrates a detailed schematic of an example of the inputs and outputs of the patch encoder and pose-patch image generator of the trained machine learning diffusion model of FIGS. 1 and 2.

FIG. 4 illustrates a detailed schematic of an example of the inputs and outputs of the control network and the diffusion model of the trained machine learning diffusion model of FIGS. 1 and 2.

FIG. 5 illustrates a schematic view of a second computing system according to an example of the present disclosure.

FIG. 6 is a flow chart of a method for generating a synthesized image according to an example embodiment of the present disclosure.

FIG. 7 shows an example computing environment of the present disclosure in which the first computing system of FIG. 1 or the second computing system of FIG. 5 may be enacted.

### DETAILED DESCRIPTION

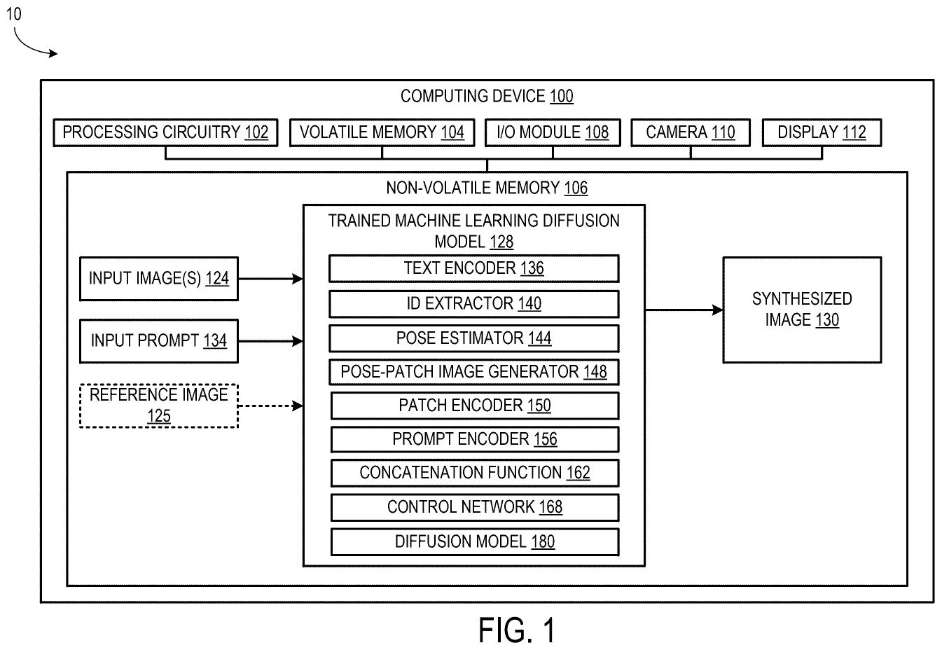

FIG. 1 shows a schematic view of a first example computing system 10 including a computing device 100 for generation of a synthesized image 130 using a trained machine learning diffusion model 128. The computing device 100 includes processing circuitry 102 (e.g., central processing units, or “CPUs”), volatile memory 104, non-volatile memory 106, an input/output (I/O) module 108, a camera 110, and a display 112. The different components are operatively coupled to one another. The non-volatile memory 106 stores instructions to execute the trained machine learning diffusion model 128 which is configured to receive one or more input images 124 and an input prompt 134 and generate the synthesized image 130 of one or more individuals based at least on the one or more input images 124 and the input prompt 134. Although the first computing system 10 generates a synthesized image 130 including two individuals this example, it will be appreciated that the number of individuals depicted in the synthesized image 130 is not particularly limited. The synthesized image 130 may depict only one individual or more than two individuals in alternative embodiments.

The trained machine learning diffusion model 128 includes a text encoder 136, an ID extractor 140, a pose estimator 144, a pose-patch image generator 148, a patch encoder 150, a prompt encoder 156, a concatenation function, a control network 168, and a diffusion model 180. Typically, the diffusion model 180 has a latent diffusion model architecture and the control network 168 is a neural network that takes an image as input to provide conditioning and steer generation of the image by the diffusion model 180. In one specific example, the diffusion model 180 may be the Stable Diffusion model and the control network 168 may be the ControlNet for the Stable Diffusion model. The ID extractor 140 is configured to extract one or more identification images from the one or more input images 124. The pose estimator 144 is configured to generate a pose image. The patch encoder 150 is configured to generate one or more identification patches based on the one or more identification images, respectively. The pose-patch image generator 148 is configured to generate a pose-patch image based on the pose image and the one or more identification patches. The text encoder 136 is configured to generate token embeddings based on the input prompt. The prompt encoder 156 is configured to generate word tokens based on the one or more identification images, respectively. The concatenation function 162 is configured to concatenate the token embeddings and the word tokens to generate concatenated token embeddings. The control network 168 receives input of the pose-patch image 166 and the concatenated token embeddings to generate features that are inputted into the diffusion model 180. The concatenated token embeddings are inputted into the diffusion model 180 to guide the denoising process to generate the synthesized image 130 from latent noise, and an output is generated based on the synthesized image 130. For example, the synthesized image 130 may be outputted for rendering on the display 112 and/or encoded by a video encoder to generate and output a video stream incorporating the synthesized image 130. The synthesized image 130 may be published or shared on a social network platform for viewing by other users of the social network platform.

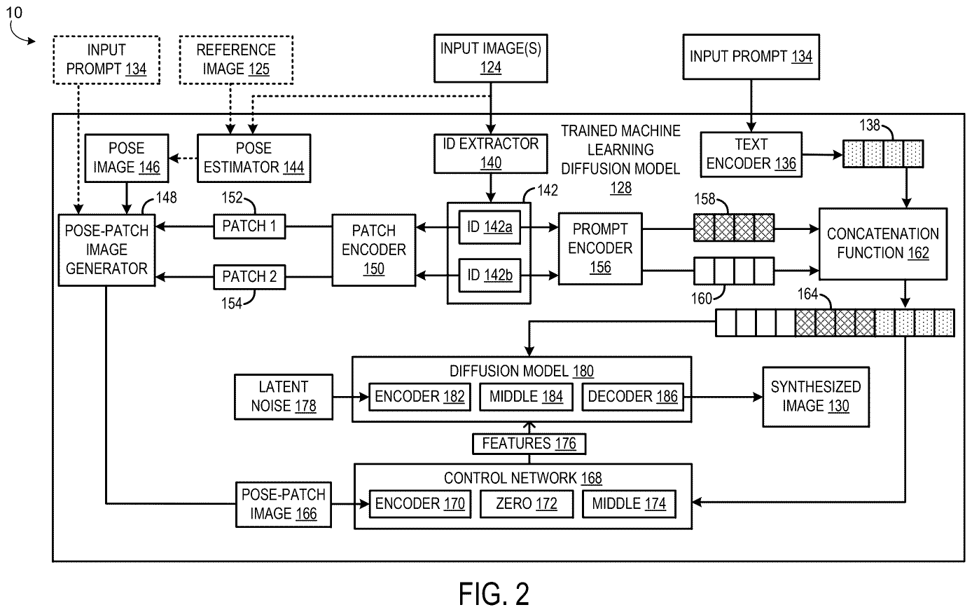

FIG. 2 shows a detailed schematic view of the processes of the trained machine learning diffusion model 128 of FIG. 1 which is configured to receive input of one or more input images 124 and an input prompt 134, and generate and output a synthesized image 130 based on the one or more input images 124 and the input prompt 134. The trained machine learning diffusion model 128 includes an ID extractor 140 which is configured to receive one or more input images 124 and generate one or more identification image 142a, 142b, which may be collectively organized into an identification image set 142. The identification image 142a, 142b are derived from the one or more input images 124 and may take the form of cropped bodily features of each individual identified in the one or more input images 124. For example, each identification image 142a, 142b may isolate and represent the face of an individual identified in the one or more input images 124.

A pose estimator 144 may be configured to generate a pose image 146 based on the one or more input images 124 or a reference image 125 depicting poses of one or more individuals. The pose estimator 144 may identify one or more individuals present within the one or more input images 124 or reference image 125 and determine their respective poses. The poses in the pose image 146 may be represented using a series of vectors connected by nodes, where each node corresponds to a key joint position such as shoulders, elbows, wrists, hips, knees, and ankles. The resulting pose image 146 is a pixelated image of a vector-based representation which depicts simplified skeletal structures of the one or more individuals, capturing the spatial arrangement and orientation of their body parts. Alternatively, the pose image 146 may be manually inputted by a user through manual annotation of the one or more input images 124 or another image, or inputted by motion capture systems which track the motion of individuals wearing specialized tracking devices, such as cameras and markers.

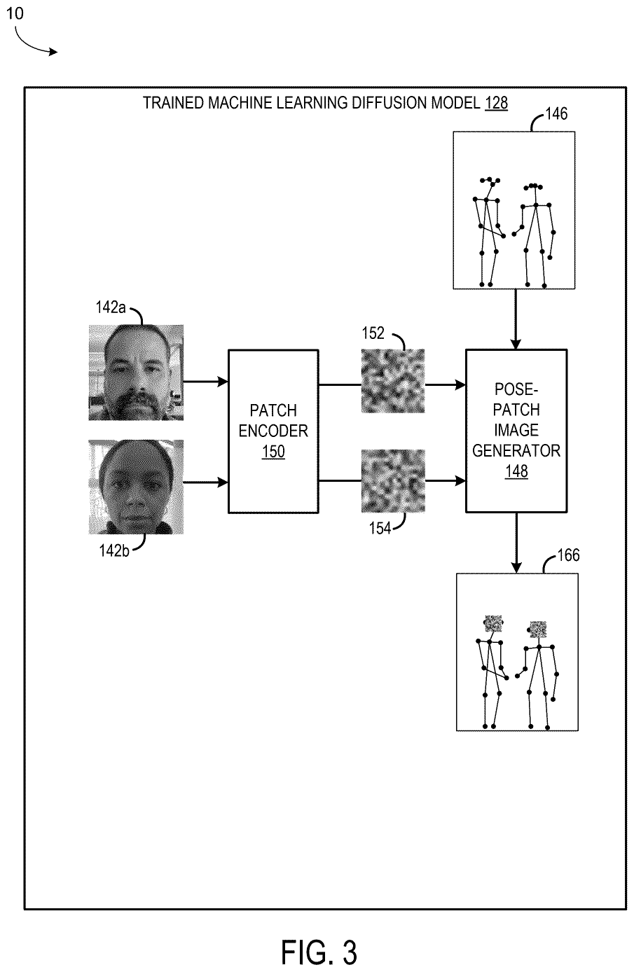

Turning to FIG. 3, the process executed by the trained machine learning diffusion model 128 of using inputs of a pose image 146 and identification images 142a, 142b to generate a pose-patch image 166 is depicted in detail. The identification images 142a, 142b are inputted into a patch encoder 150 to generate respective identification patches 152, 154. In this example, the first identification image 142a and the second identification image 142b are cropped faces of individuals who were identified in the one or more input images 124 by the ID extractor 140. The first identification patch 152 corresponds to the first identification image 142a, and the second identification patch 154 corresponds to the second identification image 142b. In the simplest embodiment, these identification patches 152, 154 may take the form of square patches. Each identification patch 152, 154 may encode feature vectors as pixel information, utilizing the color channels of each pixel to store relevant data. In some alternative embodiments, the identification patches 152, 154 may not encode visual features; instead, the identification patches 152, 154 may represent an integer or another form of non-visual data. The visual features rendered in the identification patches 152, 154 may capture essential characteristics from the one or more input images 124, such as facial features.

A pose-patch image generator 148 is configured to combine the identification patches 152, 154 with the pose image 146 to generate a pose-patch image 166, in which the identification patches 152, 154 are superimposed onto the pose image 146. In this example, the first identification patch 152 is superimposed onto the head position of the left individual in the pose image 146, and the second identification patch 154 is superimposed onto the head position of the right individual in the pose image 146. The pose-patch image generator 148 may use a combination of contextual information and predefined instructions to accurately position the identification patches 152, 154 onto the anatomical structures represented in the pose image 146. In one embodiment, the pose-patch image generator 148 may process the input prompt 134 that specifies the target positions for the patches, such as “place the first identification image onto the head position of the left individual” and “place the second identification image onto the head position of the right individual.” The instructions of the input prompt 134 may be used by the pose-patch image generator 148 to map each identification patch 152, 154 to the corresponding positions of the individuals within the pose image 146.

Additionally, the pose-patch image generator 148 may include logic for determining the anatomical locations within the pose image 146, such as the head, arms, torso, and legs. This logic may be used by the pose-patch image generator 148 to interpret the pose vectors and nodes and recognize the spatial arrangement of different body parts. By analyzing the vectors and nodes that define each pose, the pose-patch image generator 148 may identify specific anatomical regions, such as the head position based on the uppermost node, or the torso position by identifying the center between shoulder and hip nodes.

The pose-patch image generator 148 may determine where to superimpose the identification patches 152, 154 in the pose image 146 to generate the pose-patch image 166 based on a combination of the structural analysis conducted using the logic and the contextual input prompt 134. For example, if the input prompt 134 indicates that the identification images 142a, 142b represent facial features of the individuals, the pose-patch image generator 148 may leverages its understanding of the pose structures in the pose image 146 to align the identification patches 152, 154 with the corresponding head positions in the pose image 146. This alignment can be based at least on geometric center positioning or proportional scaling (e.g., adjusting the size of the patch to fit within a detected head boundary), for example. In the absence of the input prompt 134, the pose-patch image generator 148 may rely on contextual cues inferred from the pose image 146 itself, such as the relative positions of multiple individuals.

Returning to FIG. 2, the identification images 142a, 142b are inputted into a prompt encoder 156, which is configured to generate a set of respective word tokens 158, 160 based on the identification images 142a, 142b, respectively. The prompt encoder 156 may be configured as a CLIP (Contrastive Language-Image Pre-Training) text encoder, for example. In this example, the first word token 158 corresponds to the first identification image 142a, and the second word token 160 corresponds to the second identification image 142b. The token space of the prompt encoder 156 is used not to encode natural language descriptions of the face or other body parts. Instead, the token space is used to map person-specific visual information of each identification image 142a, 142b into the natural language token space of the prompt encoder 156.

When an input prompt 134 is received by the trained machine learning diffusion model 128, a text encoder is configured to generate token embeddings 138 based on the input prompt 134, which may include a description of how the final image 130 is to be synthesized. For example, the input prompt 134 may describe the arrangements of the identification images 142a, 142b within the final image 130, such as “the two individuals are shaking hands”, “the individuals are inside an ornate ballroom”, “place the first identification image onto the head position of the left individual”, and/or “place the second identification image onto the head position of the right individual”, for example. A concatenation function 162 concatenates the word tokens 158, 160 generated by the prompt encoder 156 and the token embeddings 138 generated by the text encoder 136 together to generate concatenated token embeddings 164. Accordingly, the concatenation function 162 stacks together the identification features of the identification images 142a, 142b captured by the word tokens 158, 160 as well as the prompt features of the input prompt 134 captured by the token embeddings 138, thereby integrating the identification features of the identification images 142a, 142b and the prompt features of the input prompt 134 together in one embedding 164.

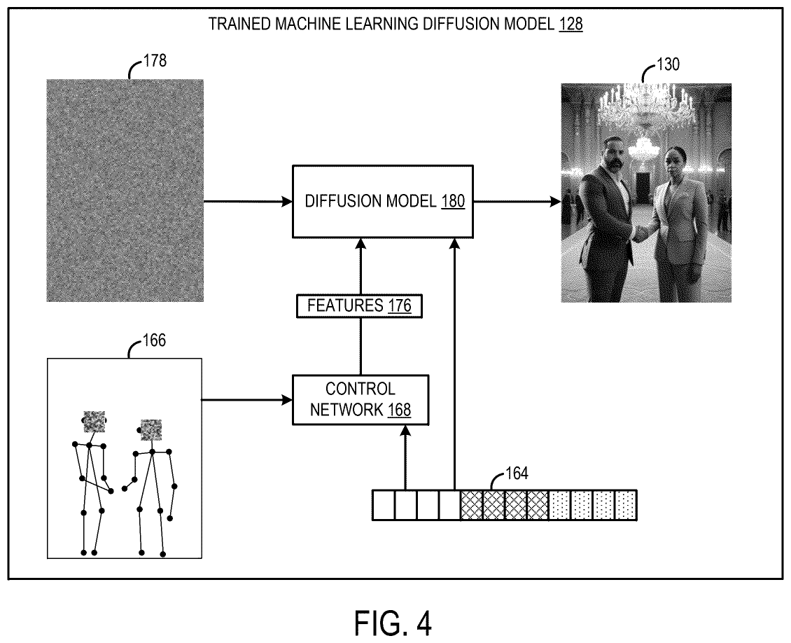

Turning to FIG. 4, the process executed by the trained machine learning diffusion model 128 of using inputs of a pose-patch image 166 and concatenated token embeddings 164 to generate the final synthesized image 130 is depicted in detail. The concatenated token embeddings 164 and the pose-patch image 166 used by a control network 168 to generate features 176. Latent noise 178, the generated features 176, and the concatenated token embeddings 164 are inputted into the diffusion model 180 to generate the final synthesized image 130. In this example, the first identification image 142a of a man is superimposed onto the head position of the left individual, and the second identification image 142b of a woman is superimposed onto the head position of the right individual in the synthesized image 130. The poses of the individuals in the synthesized image 130 of both individuals standing and shaking hands are arranged in accordance with the poses depicted in the pose-patch image 166. The ballroom setting of the synthesized image 130 is in accordance with the input prompt 134, which specified a ballroom setting for the final synthesized image 130.

Returning to FIG. 2, the architectures of the control network 168 and the diffusion model 180 are described in further detail. The diffusion model 180 is a pre-trained diffusion model that generates images from latent noise 178 through iterative denoising steps, in which the noise 178 is processed through a series of convolutional layers and attention mechanisms to progressively refine the image. The layers and mechanisms include an encoder 182 comprising a first set of blocks, a middle block 184 comprising a second set of blocks, and a decoder 186 comprising a third set of blocks. The encoder 182 downsamples the latent noise 178, and the decoder 186 upsamples the latent representations back to the original resolution to generate the final image 130.

The diffusion model 180 uses U-Net architecture, which processes the noise in a denoising process through a series of ResNet blocks and attention layers in the encoder 182, the middle block 184, and the decoder 186, progressively refining the image to generate the final synthesized image 130. The concatenated token embeddings 164 are inputted into the attention layers of the encoder 182, the middle block 184, and/or the decoder 186 of the diffusion model 180 as the denoising process progresses so that the final synthesized image 130 reflects the identification features of the identification images 142a, 142b and the prompt features of the input prompt 134.

The control network 168 comprises an encoder 170 which is a trainable copy of the encoder 182 of the diffusion model 180. The control network 168 also includes zero-initialized convolutional layers 172 that are placed at the output of the encoder 170, and a middle block 174 which is a trainable copy of the middle block 184 of the diffusion model 180. The pose-patch image 166 is inputted into the encoder 170 of the control network 168. The concatenated token embeddings 164 may be inputted into the attention layers of the encoder 170 and/or the middle block 174. The zero-initialized convolutional layers 172, which are 1×1 convolutional layers with both weights and biases introduced to zeros, transform the features generated by the encoder 170 before injection into the diffusion model 180 as features 176 or control signals of the control network 168. The features 176 outputted by the control network 168 are inputted into the skip-connections and middle block 184 of the diffusion model 180. The skip-connections, which are direct links that connect the encoder layers of the encoder 182 to the corresponding decoder layers of the decoder 186, preserve spatial information that may have been lost during the downsampling process in the encoder 182.

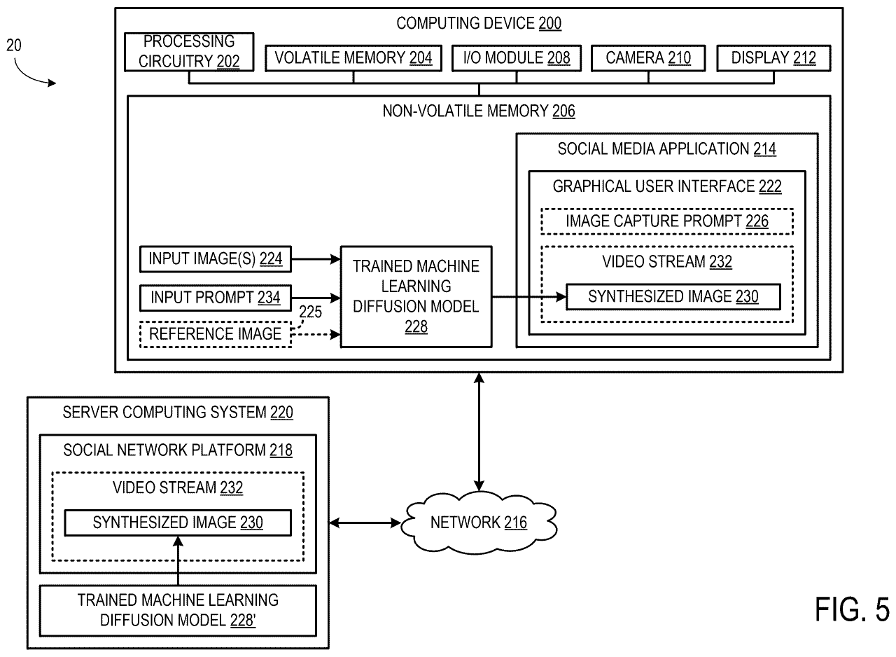

FIG. 5 shows a schematic view of a second example computing system 20 including a computing device 200 for the generation of a synthesized image 230 using a trained machine learning diffusion model 228. Like parts in this example are numbered similarly to the example of FIG. 1 and share their functions, and will not be redescribed except as below for the sake of brevity. The computing device 200 includes processing circuitry 202 (e.g., central processing units, or “CPUs”), volatile memory 204, non-volatile memory 206, an input/output (I/O) module 208, a camera 210, and a display 212. The different components are operatively coupled to one another. The non-volatile memory 206 stores instructions to execute a social media application 214.

The social media application 214 is configured to communicate via a computer network 216 with a social network platform 218 executed on a server computing system 220 of computing system 20. The social media application 214 includes a graphical user interface (GUI) 222 that is displayed via the display 212. The GUI 222 facilitates initialization of the synthesized image generation process, which includes capturing an input image 224 of at least a first face of a first user and a second face of a second user via the camera 210 using the social media application 214.

The social media application 214 may capture the input image 224 of the first user and the second user in any suitable manner. In some implementations, the social media application 214 displays an image capture prompt 226 in the GUI 222. The image capture prompt 226 directs the first user and the second user to position their faces at designated locations in a field of view of the camera 210. The social media application 214 controls the camera 210 to capture the image 224 of the two users based at least on detecting that the first user and the second user are positioned at the designated locations in the field of view of the camera 210. In other implementations, the social media application 214 automatically captures the image 224 of the first user and the second user during normal use of the social media application 214 without expressly displaying a prompt.

A trained machine learning diffusion model 228 is configured to receive the input image 224 of the first user and the second user. The trained machine learning diffusion model 228 generates at least a first identification image of the first face and a second identification image of the second face based on the input image by cropping their faces in the input image 224. At least a first identification patch and a second identification patch are generated based on the at least the first and second identification images, respectively. A pose-patch image is generated based on the first and second identification patches and a pose image. The pose image may be generated based on a reference image 225 depicting poses of one or more individuals that are to be used in the synthesized image 230.

A first word token and a second word token are generated based on the first and second identification images, respectively. Further, token embeddings are generated based on the input prompt 234, and then concatenated with word tokens that were generated based on the extracted identification images to generate concatenated token embeddings. The trained machine learning diffusion model 228 generates the synthesized image 130 based on the pose-patch image and the concatenated token embeddings.

The pose-patch image and the concatenated token embeddings are inputted into a control network to generate features. Then, the features, latent noise, and the concatenated token embeddings are inputted into a diffusion model to generate the synthesized image 230 based at least on the first identification image of the first face and the second identification image of the second face.

The synthesized image 230 includes the faces of the first user and the second user that were extracted as identification images by the trained machine learning diffusion model 228. In the synthesized image 230, the first face of the first user and the second face of the second user are depicted on individuals who are posed in the same poses as the reference image 225.

In some implementations, the trained machine learning diffusion model 228 may be executed locally on the computing device 200. In other implementations, the trained machine learning diffusion model 228′ may be executed on a remote computing system, such as the server computing system 220. In one example, the computing device 200 sends the image 224 of the users to the server computing system 220 via the computer network 216. The trained machine learning diffusion model 228′ generates the synthesized image 230 and the server computing system 220 sends the synthesized image 230 to the computing device 200 via the computer network 216.

The social media application 214 is configured to display the synthesized image 230 of the users in the GUI 222 for viewing by the user. Additionally, the social media application 214 is configured to publish or share the synthesized image 230 of the users to the social network platform 218 for viewing by other users of the social network platform 218.

In implementations where the synthesized image 230 is generated on the computing device 200, the computing device 200 sends the synthesized image 230 to the server computing system 220 via the computer network 216 to be published or shared on the social network platform 218. In implementations where the synthesized image 230 is generated on the server computing system 220, the server computing system 220 publishes the synthesized image 230 directly to the social network platform 218.

In some implementations, the social media application 214 optionally may be configured to capture a video stream 232 of the first user and the second user via the camera 210. The video stream 232 includes a sequence of images of the two users. The social media application 214 is configured to display the video stream 232 of the two users incorporating the synthesized image 230 of the one or more individuals in the GUI 222. In some examples, the video stream 232 is captured prior to the synthesized image 230 being generated and then the synthesized image 230 is incorporated into the video stream 232. For example, the synthesized image 230 can be incorporated in the background of the video stream 232. In other examples, the video stream 232 is captured subsequent to the synthesized image 230 being generated. For example, the video stream 232 can capture the users reacting to viewing the synthesized image 230. The synthesized image 230 can be incorporated into the video stream 232 in any suitable manner. Further, the social media application 214 optionally can accomplish publishing the synthesized image 230 to the social network platform 218 by publishing the video stream 232 of the users incorporating the synthesized image 230 to the social network platform 218 for viewing by other users of the social network platform 218.

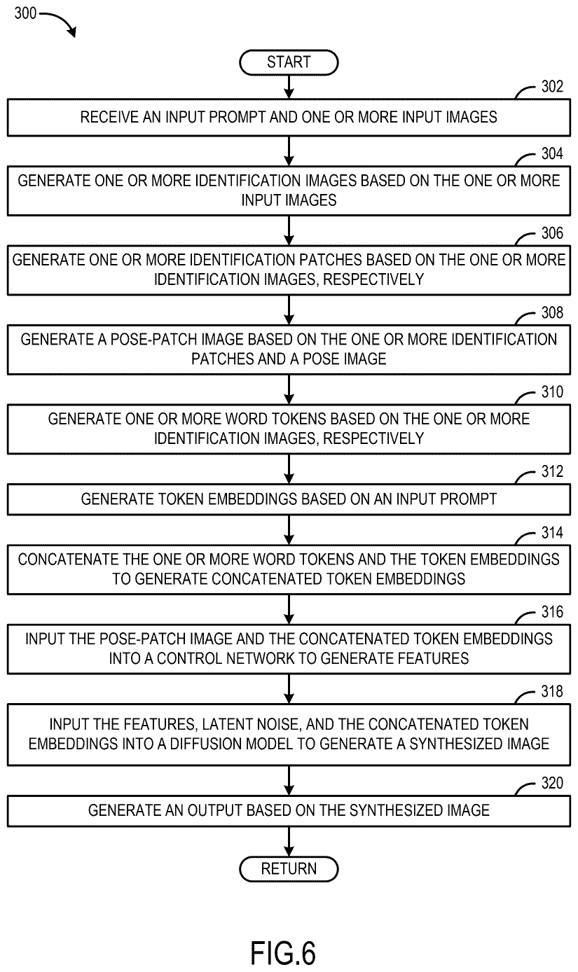

FIG. 6 shows a process flow diagram of an example method 300 for generating a synthesized image. The example method 300 may be executed by the processing circuitry 102 and memory 104 of the computing system 10 of FIG. 1 or the processing circuitry 202 and memory 204 of the computing system 20 of FIG. 2. The example method 300 includes, at step 302, receiving an input prompt and one or more input images. The first example method 300 includes, at step 304, generating one or more identification images based on the one or more input images.

At step 306, the method 300 includes generating one or more identification patches based on the one or more identification images, respectively. At step 308, the method 300 includes generating a pose-patch image based on the one or more identification patches and a pose image. At step 310, the method 300 includes generating one or more word tokens based on the one or more identification images, respectively. At step 312, the method 300 includes generating token embeddings based on an input prompt. At step 314, the method 300 includes concatenating the one or more word tokens and the token embeddings to generate concatenated token embeddings. At step 316, the method 300 includes inputting the pose-patch image and the concatenated token embeddings into a control network to generate features. At step 318, the method 300 includes inputting the features, latent noise, and the concatenated token embeddings into a diffusion model to generate the synthesized image. The diffusion model can, in some examples, be a latent diffusion model. At step 320, the method 300 includes generating an output based on the synthesized image.

As described throughout herein, by generating identification patches and pose-patch images based on identification images extracted from one or more input images, images containing multiple distinct individuals can be synthesized such that their interactions are depicted in a more realistic manner. Accordingly, the limitations of conventional attention-based mechanisms can be overcome by avoiding the issue of visual feature leakage where person-specific visual features are inadvertently blended and distinct identities of each individual are not well preserved.

In some embodiments, the methods and processes described herein may be tied to a computing system of one or more computing devices. In particular, such methods and processes may be implemented as a computer-application program or service, an Application Program Interface (API), a library, and/or other computer-program product. In some embodiments, the methods and processes described herein may be tied to a computing system of one or more computing devices. In particular, such methods and processes may be implemented as a computer-application program or service, an API, a library, and/or other computer-program product.

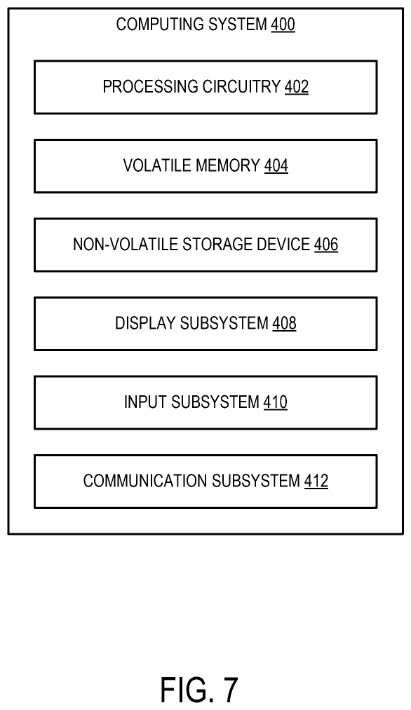

FIG. 7 schematically shows a non-limiting embodiment of a computing system 400 that can enact one or more of the methods and processes described above. Computing system 400 is shown in simplified form. Computing system 400 may embody the computing system 10 described above and illustrated in FIG. 1 or the computing system 20 described above and illustrated in FIG. 5. Components of computing system 400 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 400 includes processing circuitry 402, volatile memory 404, and a non-volatile storage device 406. Computing system 400 may optionally include a display subsystem 408, input subsystem 410, communication subsystem 412, and/or other components not shown in FIG. 7.

Processing circuitry 402 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 402 may be single-core or multi-core, and the instructions executed thereon may be configured for sequential, parallel, and/or distributed processing. Individual components of the processing circuitry 402 optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 402.

Non-volatile storage device 406 includes one or more physical devices configured to hold instructions executable by the processing circuitry 402 to implement the methods and processes described herein. When such methods and processes are implemented, the state of non-volatile storage device 406 may be transformed—e.g., to hold different data.

Non-volatile storage device 406 may include physical devices that are removable and/or built in. Non-volatile storage device 406 may include optical memory, semiconductor memory, and/or magnetic memory, or other mass storage device technology. Non-volatile storage device 406 may include nonvolatile, dynamic, static, read/write, read-only, sequential-access, location-addressable, file-addressable, and/or content-addressable devices. It will be appreciated that non-volatile storage device 406 is configured to hold instructions even when power is cut to the non-volatile storage device 406.

Volatile memory 404 may include physical devices that include random access memory. Volatile memory 404 is typically utilized by processing circuitry 402 to temporarily store information during processing of software instructions. It will be appreciated that volatile memory 404 typically does not continue to store instructions when power is cut to the volatile memory 404.

Aspects of processing circuitry 402, volatile memory 404, and non-volatile storage device 406 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 400 typically implemented in software by a processor to perform a particular function using portions of volatile memory, which function involves transformative processing that specially configures the processor to perform the function. Thus, a module, program, or engine may be instantiated via processing circuitry 402 executing instructions held by non-volatile storage device 406, using portions of volatile memory 404. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 408 may be used to present a visual representation of data held by non-volatile storage device 406. The visual representation may take the form of a graphical user interface (GUI). As the herein described methods and processes change the data held by the non-volatile storage device, and thus transform the state of the non-volatile storage device, the state of display subsystem 408 may likewise be transformed to visually represent changes in the underlying data. Display subsystem 408 may include one or more display devices utilizing virtually any type of technology. Such display devices may be combined with processing circuitry 402, volatile memory 404, and/or non-volatile storage device 406 in a shared enclosure, or such display devices may be peripheral display devices.

When included, input subsystem 410 may comprise or interface with one or more user-input devices such as a keyboard, mouse, touch screen, camera, or microphone.

When included, communication subsystem 412 may be configured to communicatively couple various computing devices described herein with each other, and with other devices. Communication subsystem 412 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 400 to send and/or receive messages to and/or from other devices via a network such as the Internet.

The following paragraphs provide additional description of the subject matter of the present disclosure. One aspect provides a computing system for generating a synthesized image, the computing system comprising processing circuitry and memory storing instructions that, when executed, cause the processing circuitry to receive an input prompt and one or more input images, generate one or more identification images based on the one or more input images, generate one or more identification patches based on the one or more identification images, respectively, generate a pose-patch image based on the one or more identification patches and a pose image, generate one or more word tokens based on the one or more identification images, respectively, generate token embeddings based on the input prompt, concatenate the one or more word tokens and the token embeddings to generate concatenated token embeddings, input the pose-patch image and the concatenated token embeddings into a control network to generate features, input the features, latent noise, and the concatenated token embeddings into a diffusion model to generate the synthesized image, and generate an output based on the synthesized image. In this aspect, additionally or alternatively, the one or more identification patches may encode visual features of the one or more identification images, respectively. In this aspect, additionally or alternatively, the one or more identification images may be cropped faces of one or more individuals identified in the one or more input images. In this aspect, additionally or alternatively, the pose image may be a pixelated image of vector representations of skeletal structures of one or more individuals. In this aspect, additionally or alternatively, the pose image may be generated based on a reference image depicting poses of one or more individuals. In this aspect, additionally or alternatively, the pose-patch image may be generated by superimposing the one or more identification patches on head positions of individuals in the pose image. In this aspect, additionally or alternatively, the one or more word tokens may be generated by a prompt encoder mapping visual information of each identification image into a natural language token space of the prompt encoder. In this aspect, additionally or alternatively, the prompt encoder may be configured as a CLIP (Contrastive Language-Image Pre-Training) text encoder. In this aspect, additionally or alternatively, the concatenated token embeddings may be inputted into attention layers of the diffusion model. In this aspect, additionally or alternatively, the control network may comprise an encoder configured to be a trainable copy of an encoder of the diffusion model, zero-initialized convolutional layers placed at an output of the encoder of the control network, and a middle block configured to be a trainable copy of a middle block of the diffusion model, the pose-patch image being inputted into the encoder of the control network, and the concatenated token embeddings being inputted into attention layers of the encoder and the middle block of the control network.

Another aspect provides a computing method for generating a synthesized image, the computing method comprising receiving an input prompt and one or more input images, generating one or more identification images based on the one or more input images, generating one or more identification patches based on the one or more identification images, respectively, generating a pose-patch image based on the one or more identification patches and a pose image, generating one or more word tokens based on the one or more identification images, respectively, generating token embeddings based on the input prompt, concatenating the one or more word tokens and the token embeddings to generate concatenated token embeddings, inputting the pose-patch image and the concatenated token embeddings into a control network to generate features, inputting the features, latent noise, and the concatenated token embeddings into a diffusion model to generate the synthesized image, and generating an output based on the synthesized image. In this aspect, additionally or alternatively, the one or more identification patches may encode visual features of the one or more identification images, respectively. In this aspect, additionally or alternatively, the one or more identification images may be cropped faces of one or more individuals identified in the one or more input images. In this aspect, additionally or alternatively, the pose image may be a pixelated image of vector representations of skeletal structures of one or more individuals. In this aspect, additionally or alternatively, the pose image may be generated based on a reference image depicting poses of one or more individuals. In this aspect, additionally or alternatively, the pose-patch image may be generated by superimposing the one or more identification patches on head positions of individuals in the pose image. In this aspect, additionally or alternatively, the one or more word tokens may be generated by a prompt encoder mapping visual information of each identification image into a natural language token space of the prompt encoder. In this aspect, additionally or alternatively, the concatenated token embeddings may be inputted into attention layers of the diffusion model. In this aspect, additionally or alternatively, the control network may comprise an encoder configured to be a trainable copy of an encoder of the diffusion model, zero-initialized convolutional layers placed at an output of the encoder of the control network, and a middle block configured to be a trainable copy of a middle block of the diffusion model, the pose-patch image being inputted into the encoder of the control network, and the concatenated token embeddings being inputted into attention layers of the encoder and the middle block of the control network.

Another aspect provides a computing device comprising a camera, a display, and processing circuitry configured to execute instructions stored in memory to execute a social media application including a graphical user interface (GUI) displayed via the display, the social media application being configured to communicate via a computer network with a social network platform executed on a server computing system, capture an input image of at least a first face of a first user and a second face of a second user via the camera using the social media application, receive an input prompt, generate at least a first identification image of the first face and a second identification image of the second face based on the input image, generate at least a first identification patch and a second identification patch based on the at least the first and second identification images, respectively, generate a pose-patch image based on the first and second identification patches and a pose image, generate a first word token and a second word token based on the first and second identification images, respectively, generate token embeddings based on the input prompt, concatenate the first and second word tokens and the token embeddings to generate concatenated token embeddings, input the pose-patch image and the concatenated token embeddings into a control network to generate features, input the features, latent noise, and the concatenated token embeddings into a diffusion model to generate a synthesized image based at least on the first identification image of the first face and the second identification image of the second face, display the synthesized image of the first user and the second user in the GUI, and publish the synthesized image of the first user and the second user to the social network platform for viewing by other users of the social network platform.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

It will be appreciated that “and/or” as used herein refers to the logical disjunction operation, and thus A and/or B has the following truth table.

| A | B | A and/or B |
|---|---|---|
| T | T | T |
| T | F | T |
| F | T | T |
| F | F | F |

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for generating a synthesized image, the computing system comprising:
processing circuitry and memory storing instructions that, when executed, cause the processing circuitry to:
receive an input prompt and one or more input images;
generate one or more identification images based on the one or more input images;
generate one or more identification patches based on the one or more identification images, respectively;
generate a pose-patch image based on the one or more identification patches and a pose image;
generate one or more word tokens based on the one or more identification images, respectively;
generate token embeddings based on the input prompt;
concatenate the one or more word tokens and the token embeddings to generate concatenated token embeddings;
input the pose-patch image and the concatenated token embeddings into a control network to generate features;
input the features, latent noise, and the concatenated token embeddings into a diffusion model to generate the synthesized image; and
generate an output based on the synthesized image.

2. The computing system of claim 1, wherein the one or more identification patches encode visual features of the one or more identification images, respectively.

3. The computing system of claim 2, wherein the one or more identification images are cropped faces of one or more individuals identified in the one or more input images.

4. The computing system of claim 1, wherein the pose image is a pixelated image of vector representations of skeletal structures of one or more individuals.

5. The computing system of claim 1, wherein the pose image is generated based on a reference image depicting poses of one or more individuals.

6. The computing system of claim 1, wherein the pose-patch image is generated by superimposing the one or more identification patches on head positions of individuals in the pose image.

7. The computing system of claim 1, wherein the one or more word tokens are generated by a prompt encoder mapping visual information of each identification image into a natural language token space of the prompt encoder.

8. The computing system of claim 7, wherein the prompt encoder is configured as a CLIP (Contrastive Language-Image Pre-Training) text encoder.

9. The computing system of claim 1, wherein the concatenated token embeddings are inputted into attention layers of the diffusion model.

10. The computing system of claim 1, wherein
the control network comprises:
an encoder configured to be a trainable copy of an encoder of the diffusion model;
zero-initialized convolutional layers placed at an output of the encoder of the control network; and
a middle block configured to be a trainable copy of a middle block of the diffusion model, wherein
the pose-patch image is inputted into the encoder of the control network; and
the concatenated token embeddings are inputted into attention layers of the encoder and the middle block of the control network.

11. A computing method for generating a synthesized image, the computing method comprising:
receiving an input prompt and one or more input images;
generating one or more identification images based on the one or more input images;
generating one or more identification patches based on the one or more identification images, respectively;
generating a pose-patch image based on the one or more identification patches and a pose image;
generating one or more word tokens based on the one or more identification images, respectively;
generating token embeddings based on the input prompt;
concatenating the one or more word tokens and the token embeddings to generate concatenated token embeddings;
inputting the pose-patch image and the concatenated token embeddings into a control network to generate features;
inputting the features, latent noise, and the concatenated token embeddings into a diffusion model to generate the synthesized image; and
generating an output based on the synthesized image.

12. The computing method of claim 11, wherein the one or more identification patches encode visual features of the one or more identification images, respectively.

13. The computing method of claim 12, wherein the one or more identification images are cropped faces of one or more individuals identified in the one or more input images.

14. The computing method of claim 11, wherein the pose image is a pixelated image of vector representations of skeletal structures of one or more individuals.

15. The computing method of claim 11, wherein the pose image is generated based on a reference image depicting poses of one or more individuals.

16. The computing method of claim 11, wherein the pose-patch image is generated by superimposing the one or more identification patches on head positions of individuals in the pose image.

17. The computing method of claim 11, wherein the one or more word tokens are generated by a prompt encoder mapping visual information of each identification image into a natural language token space of the prompt encoder.

18. The computing method of claim 11, wherein the concatenated token embeddings are inputted into attention layers of the diffusion model.

19. The computing method of claim 11, wherein
the control network comprises:
an encoder configured to be a trainable copy of an encoder of the diffusion model;
zero-initialized convolutional layers placed at an output of the encoder of the control network; and
a middle block configured to be a trainable copy of a middle block of the diffusion model, wherein
the pose-patch image is inputted into the encoder of the control network; and
the concatenated token embeddings are inputted into attention layers of the encoder and the middle block of the control network.

20. A computing device comprising:
a camera;
a display; and
processing circuitry configured to:
execute instructions stored in memory to execute a social media application including a graphical user interface (GUI) displayed via the display, the social media application being configured to communicate via a computer network with a social network platform executed on a server computing system;
capture an input image of at least a first face of a first user and a second face of a second user via the camera using the social media application;
receive an input prompt;
generate at least a first identification image of the first face and a second identification image of the second face based on the input image;
generate at least a first identification patch and a second identification patch based on the at least the first and second identification images, respectively;
generate a pose-patch image based on the first and second identification patches and a pose image;
generate a first word token and a second word token based on the first and second identification images, respectively;
generate token embeddings based on the input prompt;
concatenate the first and second word tokens and the token embeddings to generate concatenated token embeddings;
input the pose-patch image and the concatenated token embeddings into a control network to generate features;
input the features, latent noise, and the concatenated token embeddings into a diffusion model to generate a synthesized image based at least on the first identification image of the first face and the second identification image of the second face;
display the synthesized image of the first user and the second user in the GUI; and
publish the synthesized image of the first user and the second user to the social network platform for viewing by other users of the social network platform.
